(19) United States
(12) Patent Application Publication
(10) Pub. No.: US 2010/0072262 A1
(43) Pub. Date: Mar. 25, 2010

(54) Wire bonding method

(75) Inventors: Kenji Sugawara, Musashimurayama-shi (JP); Yong Chen, Musashimurayama-shi (JP)

Correspondence Address: QUINN EMANUEL;KODA & ANDROLIA, 865 S. FIGUEROA STREET, 10TH FLOOR, LOS ANGELES, CA, 90017, US

(73) Assignee: Kabushiki Kaisha Shinkawa

(21) Appl. No.: 12/284,536

(22) Filed: Sep. 23, 2008

(51) Int. Cl. B23K 31/00

(52) U.S. Cl. 228/102

(57) ABSTRACT

A wire bonding method capable of further improving accuracy in wire bonding and realizing faster wire bonding including: transferring a semiconductor chip to a bonding center; capturing an image of a bonding point on the semiconductor chip; recognizing a position of the bonding point; performing wire bonding to the bonding point that has been corrected; capturing a post-bonding image of the semiconductor chip; transferring a next semiconductor chip to the bonding center; capturing an image of a bonding point on the next semiconductor chip; recognizing a position of the bonding point of the next semiconductor chip; and then recognizing an amount of displacement in the post-bonding image of the semiconductor chip during wire bonding to the bonding point that is of the next semiconductor chip and has been corrected.

### BACKGROUND OF THE INVENTION

1. Field of the Invention

The present invention relates to wire bonding methods that optically recognize a position of a bonding point on a semiconductor device and bond a wire to the bonding point.

2. Description of Related Art

A conventional wire bonding method will be described with reference to FIG. 3 to FIG. 5. As shown in FIG. 3, for a workpiece 3 that includes a lead frame 1 and a semiconductor chip 2 attached thereto, a wire 4 is bonded between pads P1, P2, serving as first bonding points . . . on the semiconductor chip and respective lead portions L1, L2, serving as second bonding points . . . on the lead frame 1, using a wire bonding apparatus 10 shown in FIG. 4 by means of a wire bonding method.

Typically, in such a wire bonding method, first, an image pick-up device 11 detects amounts of displacement from regular positions of at least two fixed points on the semiconductor chip 2 and at least two fixed points on the lead frame 1, and then a calculation unit corrects prestored bonding coordinates based on the detected amounts of displacement. In a case in which the detection is carried out by the image pick-up device 11, an X motor 12 and a Y motor 13 are driven so that the central axis 11a of the image pick-up device 11 comes exactly above a point of measurement. After the bonding coordinates are corrected as described above, the capillary 15 is moved in an X-Y direction and a Z direction, and the wire 4 inserted through the capillary 15 is bonded between the pads P1, P2, . . . of the semiconductor chip 2 and the corresponding respective lead portions L1, L2, . . . of the lead frame 1.

In this case, since the central axis 11a of the image pick-up device 11 and the central axis 15a of the capillary 15 are offset by a distance W, the bonding coordinates are corrected after the amounts of displacement from fixed points are detected by the image pick-up device 11, and then, the X motor 12 and the Y motor 13 move the X-Y table 16 by the distance W, so that the capillary 15 is positioned above a first bonding position of the workpiece 3. Subsequently, based on the movement of the X-Y table 16 in the X-Y direction by the X motor 12 and the Y motor 13 and on the movement of the capillary 15 in the Z direction by the capillary arm 17 being moved up and down (or caused to swing) by a Z motor 14, the wire 4 is bonded at the corrected bonding coordinates. In FIG. 4, the capillary arm 17 is swingably provided on the bonding head 18, and the image pick-up device 11 is fixed to the bonding head 18 via a pick-up device holding arm 19. In the drawing, Xw indicates an X-axis component of the amount of offset W, and Yw indicates a Y-axis component of the amount of offset W.

The above wire bonding method includes capturing an image of the bonding point and recognizing the position of the bonding point. However, in the wire bonding apparatus 10, changes in the ambient temperature caused by heat sources as well as operating heat generation produce a difference between the thermal expansion of the capillary arm 17 and of the pick-up device holding arm 19 that holds the image pick-up device 11. Consequently, the amount of offset W between the central axis 11a of the image pick-up device 11 and the central axis 15a of the capillary 15 varies. An error due to this variation is expressed as displacement of the bonding position. Generally, the detection of the displacement of the bonding position is realized by detecting central positions or displacement of balls bonded to the pads P1, P2, . . . (referred to as pressure-bonded balls) using the image pick-up device 11.

Conventionally, a wire bonding method including recognizing the position of the bonding point as described above and recognizing a post-bonding image after bonding is carried out according to the steps shown in the flowchart in FIG. 5. When a semiconductor chip 2A that is a leading chip on the lead frame 1 is transferred to a bonding center (the central axis 11a of the image pick-up device 11) in Chip Transfer Step 20 and positioned in place, the image pick-up device 11 captures an image of a bonding point of the semiconductor chip 2A in Bonding Point Image Capture Step 21. Then, the image taken by the image pick-up device 11 is compared with an image of the bonding point, and an amount of displacement of the bonding point of the semiconductor chip 2A is calculated in Bonding Position Recognize Step 22. After this bonding position recognition is completed at Recognition Complete Step 23, a wire is bonded to the bonding point that has been corrected in Wire Bonding Step 24. Thereafter, a post-bonding image of a pressure-bonded ball that has been formed on the semiconductor chip 2A after bonding is captured in Post-Bonding Image Capture Step 25, and then an amount of displacement in the post-bonding image is recognized in Post-Bonding Image Recognition Step 26. After this Post-Bonding Image Recognize Step 26 is completed, in Recognition Complete Step 27, if any displacement is detected, the amount of offset W described above is corrected.

Subsequently, a semiconductor chip 2B that is a second chip on the lead frame 1 is transferred to the bonding center (the central axis 11a of the image pick-up device 11) in Transfer Step 30 and treated in the same manner as the semiconductor chip 2A. Specifically, the semiconductor chip 2B goes through Bonding Point Image Capture Step 31, Bonding Position Recognize Step 32, Recognition Complete Step 33, and then Wire Bonding Step 34. Thereafter, a post-bonding image of a pressure-bonded ball formed on the semiconductor chip 2B after bonding is captured in Post-Bonding Image Capture Step 35, and then an amount of displacement in the post-bonding image is recognized in Post-Bonding Image Recognize Step 36. After this post-bonding image recognition is completed, at Recognition Complete Step 37, if any displacement is detected, the amount of offset W described above is corrected. Examples of this type of wire bonding are disclosed in Japanese Patent Application Unexamined Publication Disclosure No. 8-31863 (Japanese Patent No. 3235008) and Japanese Patent Application Unexamined Publication Disclosure No. 9-306939 (Japanese Patent No. 3560731). As shown by the two-dot chain lines in FIG. 5, the technique disclosed in Japanese Patent Application Unexamined Publication Disclosure No. 9-306939 (Japanese Patent No. 3560731) aims to realize faster wire bonding by carrying out Transfer Steps 30 and 40 for the semiconductor chips 2B and 2C in parallel with Bonding Position Recognize Steps 22 and 32, respectively.

Another example of a technique that realizes faster wire bonding is Japanese Patent Application Unexamined Publication Disclosure No. 9-36164. In the technique disclosed in Japanese Patent Application Unexamined Publication Disclosure No. 9-36164, an amount of offset between a capillary and a lighting device having a camera (image pick-up device) is equal to the integral multiple of a pitch between semiconductor chips. In order to set the amount of offset between the capillary and the image pick-up device to the integral multiple of the pitch between semiconductor chips, the image pick-up device is attached to a bonding head such that the image pick-up device is allowed to move along the X direction. Here, when the amount of offset is, for example, equal to the pitch between semiconductor chips, capturing and recognizing an image of a first semiconductor chip that has already been wire bonded is carried out during the wire bonding to a second semiconductor chip.

For semiconductor devices for an automobile, for example, an one hundred percent inspection for pressure-bonded balls after wire bonding is a must in order to improve the reliability in the manufacturing process. However, when Post-Bonding Image Recognize Step 26 for recognizing the post-bonding image of the semiconductor chip 2A is carried out using the method shown in FIG. 5, given that the recognition of a single wire takes 0.05 seconds, it takes 12 seconds to complete the recognition of 240 wires, thus cutting into productivity.

In contrast, the technique disclosed in Japanese Patent Application Unexamined Publication Disclosure No. 9-36164 recognizes an image of the semiconductor chip after wire bonding during wire bonding to a second semiconductor chip. Consequently, it is possible to eliminate waste in time to a large extent, thereby improving the productivity. However, the capturing of an image after wire bonding is carried out after the next semiconductor chip is transferred to the bonding center, that is, the image of is captured after the semiconductor chip that has been wire bonded is transferred by a distance equal to the integral multiple of the pitch. This means that the position (stage) for wire bonding is different from the position (stage) for capturing of an image after wire bonding, and thus resulting in problems as described below.

Firstly, in a case in which a semiconductor chip that has been wire bonded at a wire bonding position is transferred to an image capturing position, it is practically impossible to place the semiconductor chip in exactly the same condition at the two different positions (stations) on the order of a micrometer, and it is also impossible to place a lead frame in exactly the same condition at the two different positions. Therefore, measuring the semiconductor chip at a different position from the wire bonding position (station) and correcting (feeding back to the capillary) the amount of offset based on the result of the measurement cannot provide an appropriate amount of offset, and thus failing to carry out the wire bonding accurately.

Secondly, detection conditions such as temperatures and lighting are slightly different between the wire bonding position and the image capturing position. In addition, the detection conditions can change over time slightly because the image after wire bonding is captured after the semiconductor chip that has been wire bonded is transferred. Therefore, similarly to the first problem, correcting (feeding back to the capillary) the amount of offset based on the result of the measurement cannot provide an appropriate amount of offset due to the differences in the detection conditions as described above, and thus failing to carry out the wire bonding accurately.

### SUMMARY OF THE INVENTION

Thus, an object of the present invention is to provide a wire bonding method capable of further improving the accuracy in wire bonding and realizing faster wire bonding.

In order to achieve the above described object, the present invention provides a wire bonding method including the steps, sequentially carried out using a wire bonding apparatus provided with a capillary through which a wire is inserted and an image pick-up device that is offset from the capillary, of:
transferring a first semiconductor chip to a bonding center;
capturing an image, using the image pick-up device, of a first bonding point on the first semiconductor chip;
recognizing a position of the first bonding point to calculate an amount of displacement of a position of the first bonding point, which is based on the captured image;
performing wire bonding of the wire from the first bonding point to a second bonding point of the first semiconductor that has been corrected based on the amount of displacement for the first semiconductor;
capturing a post-bonding image of the first semiconductor chip after bonding;
recognizing an amount of displacement in the post-bonding image; and
correcting, if any displacement is detected in the post-bonding image, an amount of the offset between the image pick-up device and the capillary, wherein

the step of recognizing the amount of displacement in the post-bonding image of the first semiconductor chip is carried out during wire bonding of the wire from a first bonding point to a second bonding point of a second semiconductor chip, the wire bonding being performed from a first bonding point to a second bonding point of the second semiconductor that has been corrected based on the amount of displacement for the second semiconductor, following the steps, sequentially carried out after capturing the post-bonding image of the first semiconductor chip after bonding, of:
transferring the second semiconductor chip to the bonding center;
capturing an image, using the image pick-up device, of the second bonding point on the second semiconductor chip; and
recognizing a position of the second bonding point to calculate an amount of displacement of a position of the second bonding point.

According to the wire bonding method of the present invention, the step of recognizing the amount of displacement in the post-bonding image of the first semiconductor chip is carried out during wire bonding of the wire from a first bonding point to a second bonding point of a second semiconductor chip, this wire bonding being performed from a first bonding point to a second bonding point of the second semiconductor that has been corrected based on the amount of displacement for the second semiconductor, following the steps, sequentially carried out after capturing the post-bonding image of the first semiconductor chip after bonding, of: transferring the second semiconductor chip to the bonding center; capturing an image, using the image pick-up device, of the second bonding point on the second semiconductor chip; and recognizing a position of the second bonding point to calculate an amount of displacement of a position of the second bonding point. Accordingly, accuracy in image capturing does not decrease and faster wire bonding can be realized.

### BRIEF DESCRIPTION OF THE DRAWINGS

FIG. 1 is a flowchart illustrating an exemplary embodiment of a wire bonding method according to the present invention;

FIGS. 2(a)-2(f) are diagrams illustrating an exemplary embodiment of a flow of image processing according to the present invention;

FIG. 3 is a plan view illustrating an exemplary embodiment of a workpiece according to the present invention;

FIG. 4 is a perspective view illustrating an exemplary embodiment of a wire bonding apparatus according to the present invention; and

FIG. 5 is a flowchart illustrating a conventional wire bonding method.

### DETAILED DESCRIPTION OF THE INVENTION

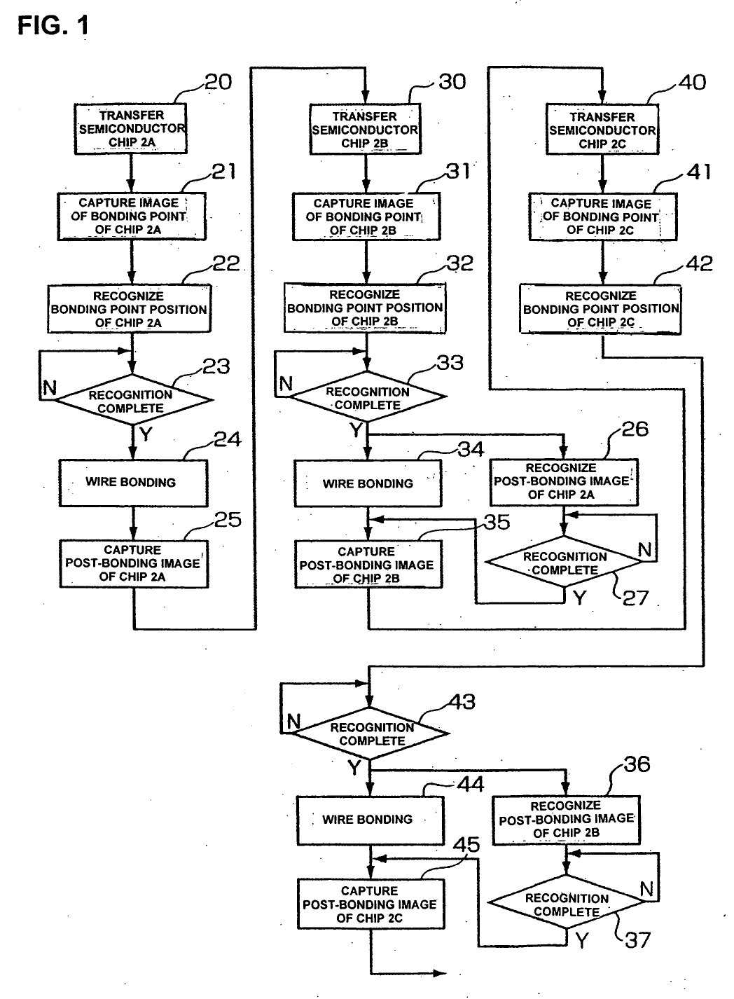

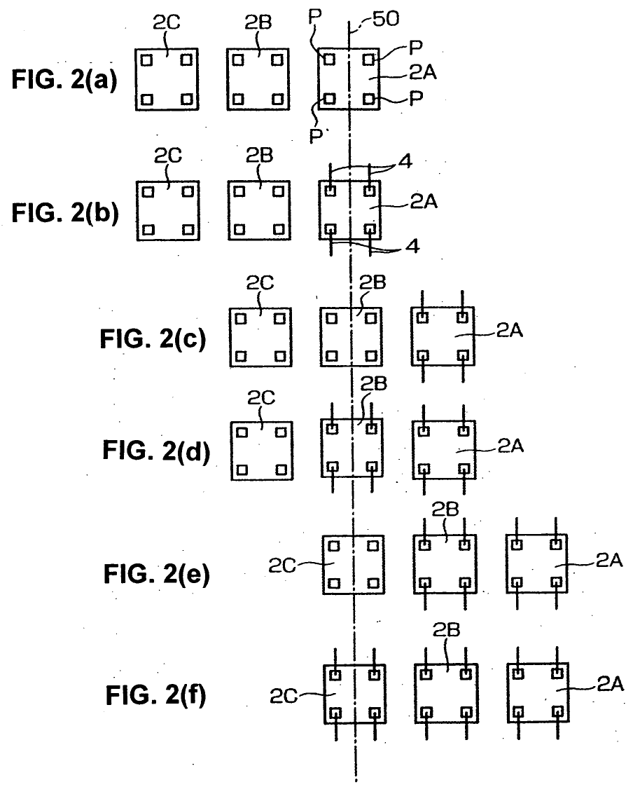

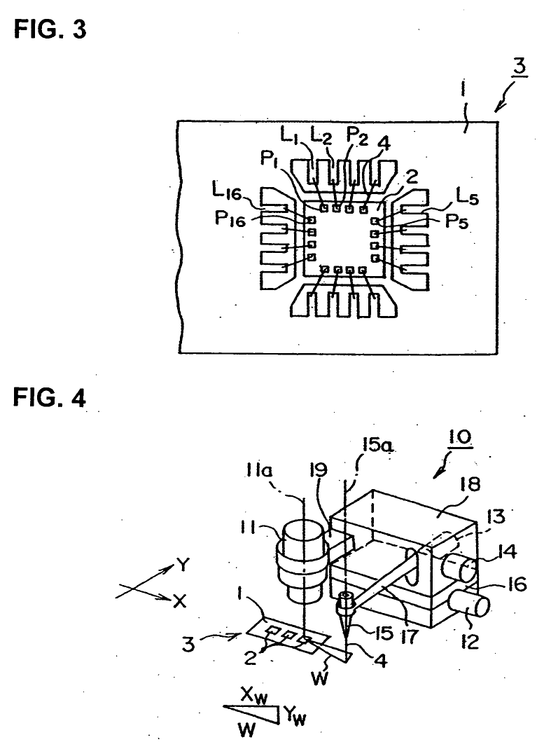

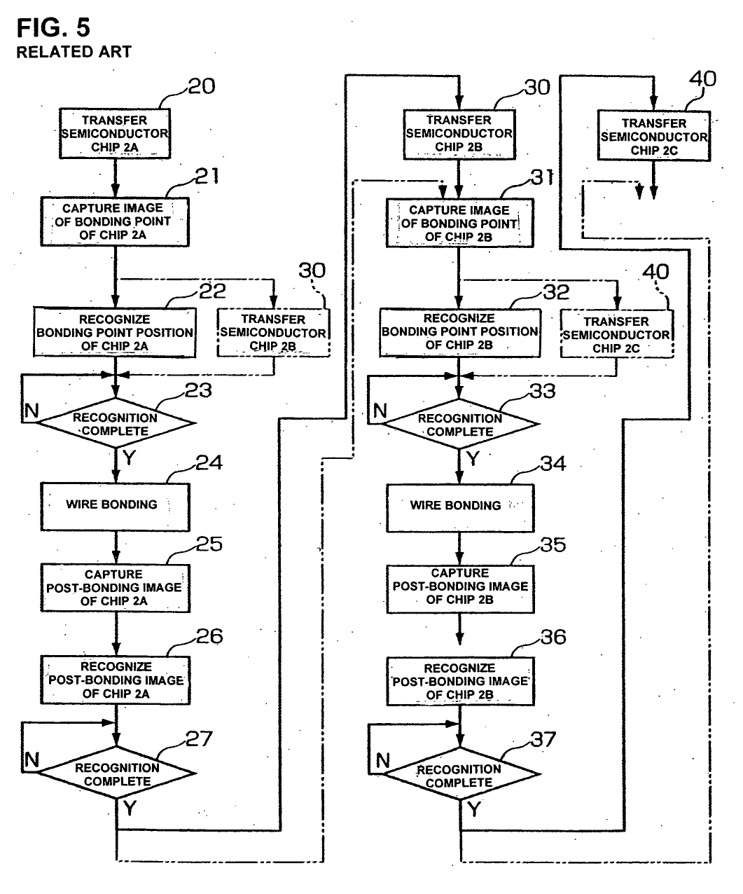

One embodiment of the wire bonding method according to the present invention will be described below with reference to FIG. 1 and FIG. 2. In the description, the like portions and components as those in FIG. 3 to FIG. 5 are indicated by the like reference numerals. The difference between the wire bonding method according to the present invention and the conventional method can be seen from the comparison between the steps shown in FIG. 1 and the conventional steps shown in FIG. 5. In the conventional method shown in FIG. 5, Post-Bonding Image Recognize Steps 26, 36, . . . are respectively carried out immediately after Post-Bonding Image Capture Steps 25, 35, . . . of each capturing of an image of the corresponding semiconductor chip (2A, 2B, . . . ) after wire bonding. In contrast, in this embodiment of the present invention, as shown in FIG. 1, Post-Bonding Image Recognize Steps 26, 36, . . . are not carried out immediately after Post-Bonding Image Capture Steps 25, 35, . . . of each capturing of an image of the corresponding semiconductor chip (2A, 2B, . . . ) after wire bonding. Instead, Post-Bonding Image Recognize Steps 26, 36, . . . are carried out respectively during Wire Bonding Steps 34, 44, . . . of each bonding of a wire to the corresponding (or the next) semiconductor chip (2B, 2C, . . . ).

Next, the embodiment will be described based on FIG. 1 and FIG. 2 with reference to FIG. 3 and FIG. 4. When a semiconductor chip 2A that is a leading chip on a lead frame 1 is transferred to the bonding center 50 (see FIG. 2(a)) (a central axis 11a of an image pick-up device 11) in Tip Transfer Step 20 and positioned in place, the image pick-up device 11 captures an image of a bonding point of the semiconductor chip 2A in Bonding Point Image Capture Step 21. Then, the image taken by the image pick-up device 11 is compared with an image of the bonding point, and an amount of displacement of the bonding point of the semiconductor chip 2A is calculated in Bonding Position Recognize Step 22. After this bonding position recognition is completed at Recognition Complete Step 23, a wire is bonded in Wire Bonding Step 24 to the bonding point that has been corrected (see FIG. 2(b)). Thereafter, in Post-Bonding Image Capture Step 25 a post-bonding image of a pressure-bonded ball that has been formed on the semiconductor chip 2A after bonding is captured. These steps are the same as the steps included in the conventional method (FIG. 5).

Subsequently, a semiconductor chip 2B that is a second chip on the lead frame 1 is transferred to the bonding center 50 (see FIG. 2(c)) (the central axis 11a of the image pick-up device 11) in Transfer Step 30 and treated in the same manner as for the semiconductor chip 2A. Specifically, the semiconductor chip 2B goes through Bonding Point Image Capture Step 31, Bonding Position Recognize Step 32, Recognition Complete Step 33, and then Wire Bonding Step 34 (see FIG. 2(d)). In this embodiment, the processing of data captured in Post-Bonding Image Capture Step 25 carried after wire bonding to the semiconductor chip 2A, that is, Post-Bonding Image Recognize Step 26 for recognizing the post-bonding image of the semiconductor chip 2A, is carried out in parallel with Wire Bonding Step 34 for bonding a wire to the semiconductor chip 2B, at the wire bonding position (bonding center 50). When this post-bonding image recognition is completed at Recognition Complete Step 27 and if any displacement is detected, an amount of offset W is corrected. Thereafter, in Post-Bonding Image Capture Step 35 a post-bonding image of a pressure-bonded ball formed on the semiconductor chip 2B after bonding is captured.

Then, a semiconductor chip 2C that is a third chip on the lead frame 1 is transferred to the bonding center 50 (see FIG. 2(e)) (the central axis 11a of the image pick-up device 11) in Transfer Step 40 and treated in the same manner as for the semiconductor chips 2A and 2B. Specifically, the semiconductor chip 2C goes through Bonding Point Image Capture Step 41, Bonding Position Recognize Step 42, Recognition Complete Step 43, and then Wire Bonding Step 44 (see FIG. 2(f)). In this embodiment, as described above, the processing of data captured in Post-Bonding Image Capture Step 35 carried after wire bonding to the semiconductor chip 2B, that is, Post-Bonding Image Recognize Step 36 of recognizing the post-bonding image of the semiconductor chip 2B, is carried out in parallel with Wire Bonding Step 44 of bonding a wire to the semiconductor chip 2C, at the wire bonding position (bonding center 50). When this post-bonding image recognition is completed in Recognition Complete Step 37 and if any displacement is detected, the amount of offset W is corrected. Thereafter, in Post-Bonding Image Capture Step 45 a post-bonding image of a pressure-bonded ball formed on the semiconductor chip 2C after bonding is captured.

As described above, the capturing of a post-bonding image is carried out at a position at which the wire bonding to the semiconductor chips 2A, 2B, . . . is performed in Wire Bonding Steps 24, 34, . . . , respectively. Therefore, either of the first and second problems of Japanese Patent Application Unexamined Publication Disclosure No. 9-36164 as listed above does not occur. Further, Post-Bonding Image Recognize Steps 26, 36, . . . for recognizing the post-bonding images of the semiconductor chips 2A, 2B, . . . are respectively carried out during Wire Bonding Steps 34, 44, . . . to the semiconductor chips 2B, 2C, and thus faster wire bonding can be realized.

1. A wire bonding method comprising the steps, sequentially carried out using a wire bonding apparatus provided with a capillary through which a wire is inserted and an image pick-up device that is offset from the capillary, of:
transferring a first semiconductor chip to a bonding center;
capturing an image, using the image pick-up device, of a first bonding point on the first semiconductor chip;
recognizing a position of the first bonding point to calculate an amount of displacement, of a position of the first bonding point, which is based on the captured image;
performing wire bonding of the wire from the first bonding point to a second bonding point of the first semiconductor that has been corrected based on the amount of displacement for the first semiconductor;
capturing a post-bonding image of the first semiconductor chip after bonding;
recognizing an amount of displacement in the post-bonding image; and
correcting, if any displacement is detected in the post-bonding image, an amount of the offset between the image pick-up device and the capillary, wherein
the step of recognizing the amount of displacement in the post-bonding image of the first semiconductor chip is carried out during wire bonding of the wire from a first bonding point to a second bonding point of a second semiconductor chip, the wire bonding being performed from a first bonding point to a second bonding point of the second semiconductor that has been corrected based on the amount of displacement for the second semiconductor, following the steps, sequentially carried out after capturing the post-bonding image of the first semiconductor chip after bonding, of:
transferring the second semiconductor chip to the bonding center;
capturing an image, using the image pick-up device, of the second bonding point on the second semiconductor chip; and
recognizing a position of the second bonding point to calculate an amount of displacement of a position of the second bonding point.

2. The wire bonding method according to claim 1, wherein the first bonding point is provided in each pad on the semiconductor chips.

3. The wire bonding method according to claim 1, wherein the steps in claim 1 are performed for each one of a third and following semiconductor chips
